(19) United States
(12) Patent Application Publication
(10) Pub. No.: US 2021/0248592 A1
(43) Pub. Date: Aug. 12, 2021

(54) END-TO-END STORED-VALUE CARDS FOR DIFFERENT REGIONS

(71) Applicant: IIGC, Inc., San Diego, CA (US)

(72) Inventor: Hamid Lotfollahi, San Diego, CA (US)

(73) Assignee: IIGC, Inc., San Diego, CA (US)

(21) Appl. No.: 16/788,629

(22) Filed: Feb. 12, 2020

(51) Int. Cl. G06Q 20/34; G06Q 30/06; G06Q 20/40

(52) U.S. Cl. CPC G06Q 20/354; G06Q 20/4016; G06Q 30/0639

(57) ABSTRACT

SOME IMPLEMENTATIONS OF THE DISCLOSED SYSTEMS, APPARATUS, METHODS AND COMPUTER PROGRAM PRODUCTS ARE CONFIGURED FOR IMPLEMENTING END-TO-END PROCESSING OF STORED-VALUE CARDS. A PROVIDER MAY PROCESS REQUESTS FOR A RESELLER REGISTERED ON THE PROVIDER'S PLATFORM. IN ADDITION TO PROVIDING AND REDEEMING STORED-VALUE CARDS, THE PROVIDER MAY PROVIDE SERVICES SUCH AS CUSTOMER RELATIONS MANAGEMENT, FRAUD DETECTION, AND ACCOUNTING SERVICES.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### FIELD OF TECHNOLOGY

This patent document relates generally to stored-value payment cards. In particular, an end-to-end solution for digital delivery and processing of stored-value payment cards may be provided.

### BACKGROUND

E-commerce techniques allow users to purchase goods and services via the Internet by simply clicking or tapping a button in a user interface. Online social networking systems have connected people across the globe facilitating creation of friendships over the Internet. People may wish to purchase gifts to maintain friendships and strengthen bonds.

### BRIEF DESCRIPTION OF THE DRAWINGS

The included drawings are for illustrative purposes and serve only to provide examples of possible structures and operations for the disclosed inventive systems, apparatus, methods and computer program products for image-based authorization of stored-value payment cards. These drawings in no way limit any changes in form and detail that may be made by one skilled in the art without departing from the spirit and scope of the disclosed implementations.

FIG. 1 illustrates an example of a simplified block diagram of a computing environment in which a gift platform is operating, in accordance with some implementations.

FIG. 2 illustrates an example of a method for activation of stored-value payment cards, in accordance with some implementations.

FIG. 3 illustrates an example of a simplified block diagram of a computing system in which an end-to-end solution for stored-value cards is operating, in accordance with some implementations.

FIG. 4 illustrates an example of a method for end-to-end processing of stored-value cards, in accordance with some implementations.

FIG. 5 illustrates an example of a method of fraud prevention, in accordance with some implementations.

FIG. 6 illustrates one example of a computing device, configured in accordance with some implementations.

### DETAILED DESCRIPTION

Some implementations of the disclosed systems, apparatus, methods and computer program products are configured for implementing end-to-end processing of stored-value payment cards. As described in further detail below, such a platform may be provided in an environment where merchants offer stored-value payment cards to clients. The described platform may allow for merchants to be associated with the platform and for the platform to perform the creation, storage, issuance, and processing of the stored-value cards.

In various implementations, the merchant may be certain businesses and/or may resell stored-value cards associated with certain businesses. Such businesses may include, but are not limited to, a small corner store, a restaurant, a manufacturing company, a brick and mortar retail store, an E-commerce company, a law firm, a direct to consumer farm, a courier service provider, etc.

In certain implementations described in further detail below, authorization techniques may be applied to activate or validate the stored-value cards. These authorization techniques can be applied using images captured from a camera of a mobile device, from a camera connected to another device (e.g., a vending machine or kiosk), from a smart watch, from a stand-alone digital camera, etc. While mobile devices are used in the example below, one having skill in the art can appreciate that the examples of applications or services described herein may be substituted for any suitable application or device such as those described above.

Conventional authorization of gift cards requires a customer to purchase and activate a gift card according to a standard in-person retail transaction. The infrastructure required by the retail store to activate the gift card can be expensive. Smaller retail stores typically cannot afford to invest in this infrastructure, leaving customers with limited choices or where to purchase and activate their gift cards. By way of illustration, Franklin Sisters Market is a small corner grocery store owned that caters to residents located nearby the store. The Franklin Sisters Market is a modest family-owned business that is looking for a new way to attract repeat customers and expand their sales, Brit a co-owner of Franklin Sisters Market, mindful of the limited space in the store, has the idea to add a gift card stand to draw customers into the store. As Brit researches the opportunity, she finds that the cost to invest in the system for activating the gift cards would be cost-prohibitive. Consequently, Brit decides not to move forward with the gift card stand idea. Brit's decision not to add a gift card stand causes her to miss out on many new sales opportunities. As one example, Phil, a neighbor and past customer of Franklin Sisters Market, is in desperate need of a last-minute gift for his friend Juan's raw vegetable potluck-style birthday party. Phil is under the impression that only large grocery stores have gift cards. Realizing that he would be late if he had to drive the 20 minutes to the large grocery store, Phil decides not to get a gift for Juan or bring any vegetables. As a consequence, the relationship between Phil and Juan is strained and Franklin Sisters Market loses out on the sale from Phil. However, some of disclosed techniques described in further detail below can be implemented in order to avoid this unfortunate scenario for all parties involved.

Returning to the above example, during Brit's research into the gift card stand idea, she may have come across a company implementing a stored-value payment activation platform utilizing some of the disclosed image-based authorization techniques. As a result, Phil may have seen the stand during a previous visit and remembered that Franklin Sisters Market had gift cards. Instead of needing to drive the 20 minutes to the large grocery store, Phil could have walked next door to his house and activated a gift card from Franklin Sisters Market using his smart phone. As such, he would have been able to purchase a gift as well as the vegetables he wanted to bring to the pot luck.

In certain additional implementations described, end-to-end management of stored-value cards may be disclosed. A provider may provide services such as registration and on-boarding of merchants that provide stored-value cards and creation of a portal for a merchant to provide the stored-value cards to customers. The portal may receive orders for stored-value cards as, instructions for use of the stored-value cards (e.g., redemption, adding value, and other such actions with the stored-value cards), and/or other actions. The provider may accordingly provide such services.

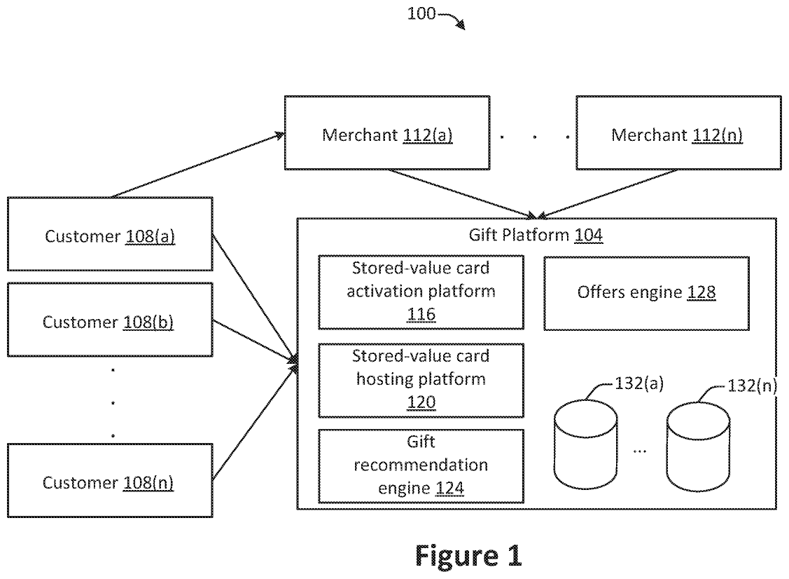

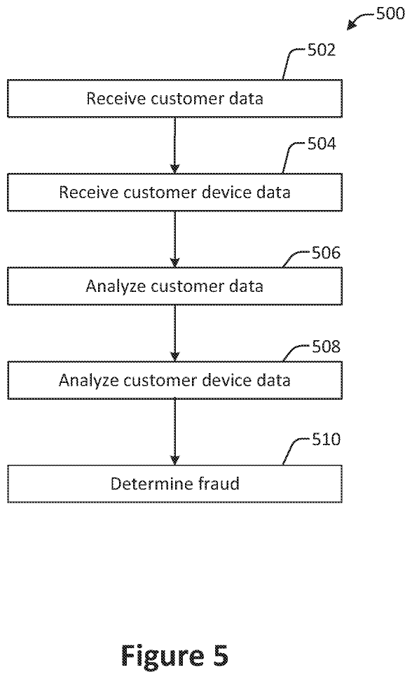

FIG. 1 illustrates an example of a simplified block diagram of a computing environment 100 in which a gift platform 104 is operating, in accordance with some implementations. The gift platform 104 may be implemented using a variety of computing devices, server systems, database systems, etc. (e.g., system 500 of FIG. 5.)

In some implementations, customers 108(a)-(n) of FIG. 1 may use computing devices to interact with the gift platform 104 for a variety of functions such as stored-value payment card activation platform 116. By way of example, the customers 108(a)-(n) may use their computing devices to purchase stored-value payment cards (e.g., gift cards) or other gifts from the gift platform 104. In another example, the customers 108(a)-(n) may use their computing devices to automatically activate stored-value payment cards via the gift platform 104 without a need for a human intermediary.

Also or alternatively, merchants 112(a)-(n) of FIG. 1 may use computing devices to interact with the gift platform 104 for a variety of functions such as stored-value payment card hosting platform 120. By way of illustration, some of the merchants 112(a)-(n) may not have the resources to maintain their own stored-value payment card services. As such, the gift platform 104 may host stored-value payment card services on behalf of some of the merchants 112(a)-(n). As such, the customers 108(a)-(n) may activate and purchase store payment cards via platform 116 and use these stored-value payment cards by purchasing goods and serviced directly from the merchants 112(a)-(n). Also or alternatively, the merchants 112(a)-(n) may also activate and purchase stored-payment cards via platform 116 and offer the stored-value payment cards directly to their customers at the merchant's physical location. One having skill in the art can appreciate that “stored-value payment cards” as described here may refer to a range of items such as a physical gift card, digital gift card, a voucher, a gift certificate, mobile gift cards stored on a smart phone, etc. Such terms may be interchangeably used. Stored-value payment cards can be delivered digitally (e.g., through email, short message system, through an app, or through another such digital technique) or physically through a mail service.

In some implementations, as discussed in further detail below, customers 108(a)-(n) and/or merchants 112(a)-(n) may use gift platform 104 to purchase and redeem stored-value payment cards. Gift platform 104 includes a gift recommendation engine 124 for providing automated gift recommendations, One having skill in the art can appreciate that “gifts” as described herein may refer to a range of subject matter and may vary across implementations. For instance, a gift may include specific goods and services (e.g., a trip, a massage, delivered food, electronics, etc.), a stored-value payment card (e.g., a gift card), a charitable donation, a greeting card, access to a group or event, etc.

Also or alternatively, the gift platform 104 through offers engine 128 may be used to provide and maintain special offers for both the customers 108(a)-(n) and the merchants 112(a)-(n). By way of example, the gift platform 104 may generate and maintain a special offer infrastructure (e.g., coupons, discounts, promotion codes, etc.) for the merchants 112(a)-(n). The gift platform 104 may also provide such special offers directly to the customers 108(a)-(n). By way of example, discounts may be automatically provided to users on special occasions such as birthdays, anniversaries, holidays, etc.

One having skill in the art can appreciate that the gift platform 104 may be provided to the customers 108(a)-(n) and the merchants 112(a)-(n) in a variety of manners, e.g., via an mobile application (app) or a web page accessible via a web browser. Also or alternatively, the gift platform 104 may maintain or access a variety of databases 132(a)-(n) to perform the above described functions or any additional functions. By way of example, one or more of databases 132(a)-(n) may include stored-value payment card data (e.g., data for particular gift cards such as balance information) for a merchant 112(a)-(n) for whom the gift platform 104 is hosting a stored-value payment card program, user account information associated with a merchant 112(a)-(n), user account information associated with customers 108(a)-(n), etc.

In some implementations, the gift platform 104 may be used for any combination of functions. By way of illustration, Franklin Sisters Market may be one of the merchants 112(a)-(n) of the gift platform 104. A customer may purchase a gift card redeemable at Franklin Sisters Market from the comfort of his living room simply using his smartphone to access an app provided by the gift platform 104. The purchased gift card may be automatically transmitted to the customer's smartwatch as a quick response (QR) code. The customer may quickly activate the gift card herself using her smartwatch via the activation function of the gift platform 104. The gift platform 104 may also be host a gift card program for Franklin Sisters Market because Franklin Sisters Market does not have the resources to maintain its own gift card program, as discussed above.

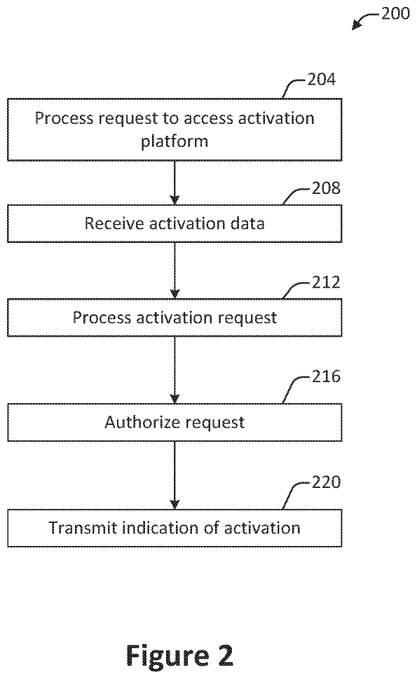

FIG. 2 illustrates an example of a method for activation of stored-value payment cards, in accordance with some implementations. FIG. 2 may be described in the context of FIG. 1.

At 204 of FIG. 2, a request for access to a stored-value payment card activation is received. By way of example, merchant 112(a) of FIG. 1 may send a request to gift platform 104. In some implementations, that request is processed by gift platform 104. In other implementations the request is routed to stored-value hosting platform 120 to be processed. And in other implementations, the request is routed to stored-value card activation platform 116. Also or alternatively, any combination of platforms 104, 116, and 120 can be used to process the request. The request may be from a new merchant to platform 120 that would like to add a stored-value payment card program for their business. Also or alternatively, the merchant may have been previously enrolled in the stored-value card hosting platform 120. If it is the case that it is the first time that a merchant is activating a stored-value payment card, then the merchant may be prompted to create an account using basic information about the merchant (name of principal, address, baking information, etc.). The request may also be from a customer (e.g., user or prospective user of the stored-value card) of the merchant or holder of a stored-value card.

The request to access the stored-value payment card activation platform may be sent in different ways. In one example, merchant 112(a) navigates to a website controlled by gift platform 104, where merchant 112(a) is prompted to enter stored-value payment card information manually on a webpage set up for card activation. Also, it could be customer 108(a) using an app controlled by gift platform 104 on their smart device and providing the necessary information to gift platform 104 via the app. In another example, it is customer 108(a) that navigates to a website controlled by gift platform 104 and enters stored-value payment card information manually on a webpage set up for card activation. In one more example, customer 108(a) would like to order and activate a stored-value payment card for a merchant not yet using the services provided by stored-value card hosting platform 120. As such, the customer can request that the merchant use stored-value payment card hosting platform 120.

In some implementations, a request is sent by gift platform 104 that includes information about the customer and a dollar amount that the customer would like to add to stored-value payment card. In addition, the request to access the stored-value payment card activation platform can also include login credentials. For example, a username and password. The login credentials can also further include financial information associated with the customer, a phone number, location of the customer, etc. In some cases, the

At block 208 of FIG. 2, activation data of the stored-value payment cards is received. Activation data may include, for example, an image of the stored-value card, an account number of the stored-value card, an activation code, customer information, metadata from an electronic device processing the activation of the stored-value card (e.g., location data of the electronic device), and/or other such data.

In examples where an image of the stored-value card is received, the image can contain an identifier representing the stored-value payment and associated information stored in a database of gift platform 104 of FIG. 1. An identifier may include a machine-readable barcode, a series of characters (numbers and/or letters), a OR code, or other means of identification. In some implementations, the identifier in the image is identified using feature recognition techniques. One example is matrix matching (also known as “pattern matching”, “pattern recognition”, or “image correlation”) techniques that compare an image to a stored base character on a pixel-by-pixel basis. The character analyzed can be isolated from the rest of the image and in a similar font and at the same scale to the stored set of base characters. Another example is feature extraction that identifies features of a character such as lines, closed loops, line direction, and line intersections. The extraction features can reduce the dimensionality of the representation and allow the recognition process to be computationally efficient. These features can be compared with an abstract vector-like representation of a character, which might reduce to one or more base set characters.

In some implementations, the activation data of block 208 of FIG. 2 is provided by customer 108(a) of FIG. 1 via an app on an electronic device such as a smart device. In some implementations, the customer activates the stored-value payment card by opening an app and taking a picture of the barcode or other identifying characters with their smart device. For example, the image may be captured on a camera of a mobile device and provided using mobile data (or a wireless Internet connection) to platform 116. In addition, more than one image can be captured by customer 108(a) and sent to platform 116 (e.g., additional images of the stored-value payment card). These additional images might be used to provide a more accurate representation of the identifier (e.g., barcode) or of additional information necessary to activate the stored-value payment card (e.g., a merchant id number, or an additional verification code). Other types of images can be provided to platform 116, for instance, an image of the user for security purposes, as discussed further below.

In some implementations, the identifier in the image of the stored-value payment cards is identified based on one or more machine learning techniques that refine and improve the accuracy of the identification process. One technique that may be used is simply adding a weight to images that are known to contain correctly identified identifiers. Using that information, visually similar images that are sent to platform 116 can be compared to the weighted correctly identified identifiers and depending on the similarity between the two images can be give a confidence score that is used indicate how confident platform 116 is that the correct characters have been identified.

In some implementations, additional data is provided as part of block 208 of FIG. 1. Data representing the position of the user can be captured using a global positioning system sensor of the mobile device and sent to platform 116 of FIG. 1. For example, Phil's location inside Franklin Sisters Market can be sent as part of the activation process. Additionally, the location information can be used for security purposes by the activation platform by matching Phil's location with the location the gift platform has in its database about Franklin Sisters Market address.

At block 212 of FIG. 2, a request to activate the stored-value payment card is received and processed. In some implementations, the request of block 212 is sent with the request of block 208. In other implementations, the request of block 212 is sent as a separate request from that of block 208. To illustrate, a user may navigate to a first presentation of a user interface on an app of a smart phone (e.g., a user interface configured to receive a real-time image). After capturing and sending the image to platform 116 of FIG. 1, the app refreshes the app to display a second presentation that shows a form to input information about the customer and financial information. An example involving these implementations is the scenario where a stored-value payment card is activated in person at a store such as the scenario described above where Franklin Sisters Market would like to stock physical gift cards at their retail location.

A determination is then made as to whether the activation request is authorized. In some implementations, the request may be authorized if an identifier is successfully identified and the financial information provided by the customer is reliable and adequate for transferring the funds from the customer's financial institution to the activation platform 116 of FIG. 1. In other implementations, additional security measures are employed to prevent fraud. For example, the customer's information may be sent to a third-party vendor for a credit check, fraud history check, etc. As part of the additional security measures, a user may take a picture of their face, credit card, driver's license, etc. to determine that the user is associated with the payment information and that the activation should be authorized. Also or alternatively, the determination can be delayed until the point when a customer attempts to use the stored-value payment card, allowing for more time to complete additional security measures concerning the customer attempting to activate the stored-value payment card.

At block 216, based on the processing of the activation request in block 212, the request may be authorized. For example, if a determination is made that the information provided in block 212 is legitimate or matches stored information, the activation request may be authorized and the stored-value card may be activated. In other implementations, activating the stored-value card may include additional authentication and/or checking steps such as determining if the credit rating of the customer is above a threshold and/or whether the customer passes a background check.

At block 220 of FIG. 2, an indication that the activation has been authorized is transmitted. When the request is authorized, funds are provided from the customer's financial institution to the provider of gift platform 104. Funds can be provided to the gift platform 104 immediately or at certain time such as at the end of business day, 24 hours from the authorization, etc. In some implementations, gift platform 104 may send a notification to merchant 112(a) indicating that the activation has been successfully authorized. In other implementations, gift platform 104 may send a notification to customer 108(a) as well. The notification may be in the form of a push notification, text message, email, phone call, or some other form of audio-visual prompt indicating successful authorization.

While various implementations have been described herein, it should be understood that the examples of activation of stored-value payment cards handled by the stored-value payment card activation platform have been presented by way of example only, and not limitation. The stored-value payment card activation platform can be configured to activate using other activation techniques including those know in the art, but not mentioned above. Furthermore, it is appreciated that other implementations are possible. For example, a complete end-to-end delivery solution for stored-value cards may utilize the examples described in FIGS. 1 and 2.

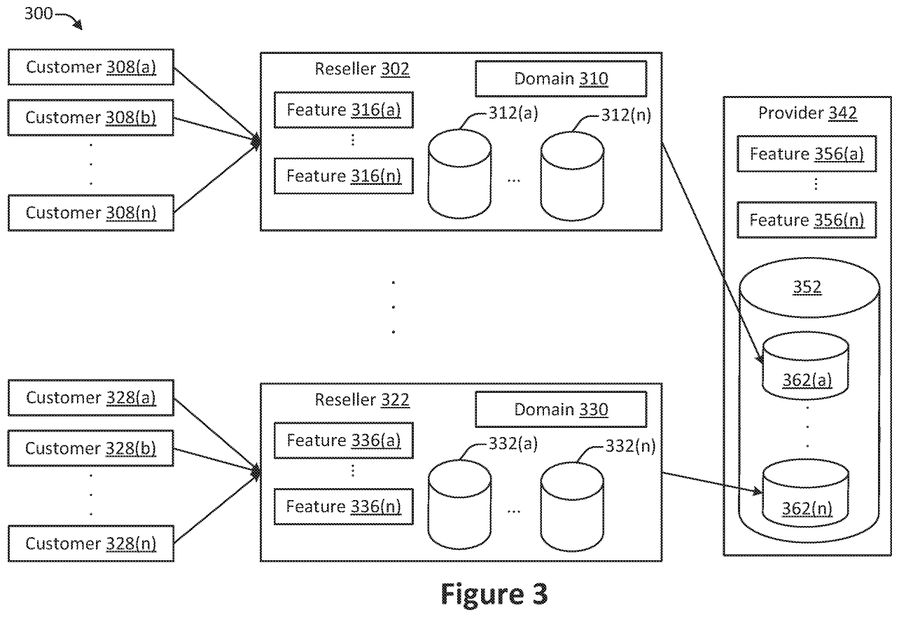

FIG. 3 illustrates an example of a simplified block diagram of a computing system in which an end-to-end solution for stored-value cards is operating, in accordance with some implementations. FIG. 3 illustrates system 300 that includes a plurality of resellers, including resellers 302 and 322, all associated with provider 342. Each of the resellers may include a plurality of customers, such as customers 308(a)-(n) for reseller 302 and customers 328(a)-(n) for reseller 322. Provider 342 may provide an end-to-end processing solution for the resellers (e.g., resellers 302 and 322). As described herein, an end-to-end digital delivery system may include a system configured to provide a complete solution. Thus, the system described herein may allow for a reseller to register with the provider and may then manage the selling process from creation of the stored-value cards to the sales to the customer to the redemption of the stored-value cards to any adding of value and to disposal of the stored-value cards.

The system may be configured such that one or more resellers may register with provider 342. Provider 342 may then configure a portal for each reseller upon registration. Provider 342 may determine one or more regions associated with the reseller during the on-boarding process. In certain implementations, the reseller may communicate regions of interest (e.g., regions that the reseller is based within and/or intending to provide stored-value cards to) directly to provider 342. Additionally or alternatively, provider 342 may receive location data from one or more electronic devices associated with the reseller and determine the location of the reseller from the location device. In certain implementations, provider 342 may, based upon the region that the reseller is intending to operate within, limit the reseller to providing stored-value cards to that region. In certain such implementations, provider 342 may include a plurality of resellers, at least some of the resellers operating in different regions.

The portal may allow for customers and potential customers to order stored-value cards and perform operations associated with the stored-value cards (e.g., redemption, adding of value, and cancellation). Each portal may include a domain associated with the reseller, such as domain 310 for reseller 302 and domain 330 for reseller 322. Based on the region that the reseller desires to provide stored-value cards to, the portal may be configured accordingly (e.g., the language of the portal may be configured based on the region). Furthermore, one or more templates (e.g., configurations of portals and/or visual themes) may be provided to the reseller. If a plurality of templates are provided, the reseller may select from one of the plurality of templates.

Provider 342 includes a plurality of features 356(a)-(n). Such features may include, for example, digital delivery, fraud prevention techniques, anti-money laundering techniques, customer information analysis, picture based authentication, automatic add value, gifting ability, PIN based activation, value transferability, acceptance of payment through different payment formats, transfer of value between different accounts, limitation of usage of the stored-value cards to certain merchants and/or category of goods, and other such features. Each of reseller 302 may select from features 356(a)-(n) for use within their own portals. Compensation may be provided for one or more of the selected features. Thus, for example, reseller 302 may select features 316(a)-(n) and reseller 322 may select features 336(a)-(n) for each of their respective portals.

In various implementations, the features available to a reseller may be dependent upon the region or geographical area of the reseller. For example, in certain regions, PIN based activation may be unavailable as a feature due to the local regulations. In such a region, provider 342 may thus not offer the feature to any resellers operating in the region.

Thus, for example, a certain feature may allow for various different payment gateways that accept various methods of payment. Different payment gateways may be associated with resellers of different geographical areas. That is, for example, certain geographical areas may not include or may additionally include different payment techniques. Armenia, for example, may include payments through ARCA and, thus, resellers that are associated with Armenia may be offered to accept payment through ARCA. Additional techniques for payment may also be offered by the provider through the gateway. Custom gateways may be developed by the resellers through APIs offered by the provider.

The various portals may allow customers to purchase stored-valued cards through the portal (e.g., through the various domains associated with the resellers). The provider may provide for digital delivery of the stored-value cards to the customer. In certain implementations, though the portal is associated with the reseller, the provider may directly provide for digital delivery (e.g., through e-mail, through an associated with account such as a digital wallet, or through another technique) as well as other services (e.g., add value, transfer value, and other such services) directly to the customer.

Additional features include providing for accounting and/or billing services to the reseller. Such services may include automated billing to various customers (e.g., for purchases and/or adding of value to stored-value cards), billing for services (e.g., from the provider), and/or billing and accounting for other services and items.

Further features may include creating, activating, tracking, billing, and disposing of various stored-value cards. In a certain implementations, the provider may determine a location that the reseller is operating within (e.g., the portal may be providing stored-value cards to a certain specific location) and stored-value cards may be configured based on the rules and regulations of such a location. Thus, for example, the stored-value card may be activated based on the regulation of the location in which it is supposed to be valid (e.g., in certain locations, a stored-value card may only be activated upon a positive confirmation of the identity of the holder). Furthermore, use of the stored-value card (e.g., redemption) may also include confirmation that the stored-value card is being used in the geographic area that it is intended to be used within.

Customers 308(a)-(n) may provide information to and sign up for or include accounts with reseller 302 and customers 328(a)-(n) may provide information to and sign up for or include accounts with reseller 322. Thus, each of customers 308(a)-(n) may include one or more accounts with reseller 302. Data directed to customers 308(a)-(n) may be stored within database 312(a)-(n). In the implementation shown in FIG. 3, data associated with each customer may be stored within each of their own container database. Thus, for example, data for customer 308(a) may be stored within database 312(a), data for customer 308(b) may be stored within database 312(b) (not shown), and data for customer 328(a) may be stored within database 332(a).

Data associated with each reseller may also be stored within separate database containers. As such, data associated with reseller 302 may be stored within container 362(a) of database 352 while data associated with reseller 322 may be stored within container 362(n) of database 352. In various implementations, the various containers associated with the various resellers may be separately structured and/or partitioned to allow for simplified access to data associated with each specific reseller.

A single reseller may operate in a plurality of different geographic areas (e.g., multiple different states, provinces, countries, or other areas with separate regulatory requirements). In certain implementations, when a reseller is associated with a plurality of different geographic areas, data associated with the different geographical areas of the reseller may be stored within different containers. Thus, for example, if a reseller operates within India and Pakistan, a plurality of domains may be configured for the reseller, one for India and one for Pakistan. Data directed to the reseller's operation in India may be stored within one container while data directed to the reseller's operation in Pakistan may be stored within another container. In various implementations, a plurality of portals may also be prepared for the reseller.

Provider 342 may access the various database containers. In certain implementations, different containers may be accessed even if certain containers are associated with resellers and/or customers that are ostensibly not party to the transaction, Thus, the configuration of system 300 may allow for fraud prevention. For example, advantageously, as provider 342 is associated with a plurality of resellers, data associated with each of the resellers may be tracked and/or accessed during a transaction. Thus, if one reseller (e.g., reseller 302) encounters a fraudulent account (e.g., customer 308(a)), the information associated with such an account (e.g., the identity, billing address, account number, payment techniques, and/or other such information) may be stored and, if such information is attempted to be utilized for another account (e.g., customer 328(a) operating in another geographical area), such an account may be flagged and subject to further verification.

In various implementations, provider 342 may create and/or manage a plurality of stored-value cards. The stored value cards may be stored within various containers of databases 312(a)-(n), 332(a)-(n), 352, and/or other such databases. The stored-value cards may be allocated to various resellers before or after customers have purchased the stored-value cards. Thus, for example, stored-value cards allocated to reseller 302 may be stored within database 362(a). A stored-value card purchased by customer 308(a) may be stored within database 312(a) and, thus, associated with customer 308(a). As such, various stored-value cards may be allocated to resellers and/or customers based on the containers that they are stored within.

Fraud detection techniques may be different based on the technical features of certain areas (e.g., certain areas may include a specific authorization technique due to stored-value cards being required to be redeemed or activated in a certain manner, such as through ID verification). Provider 342 may determine when a fraudster in another geographic area is attempting to fraudulently conduct transactions through techniques popular in another area. Resellers may also request that the provider detect certain fraud techniques that are popular in their area of business.

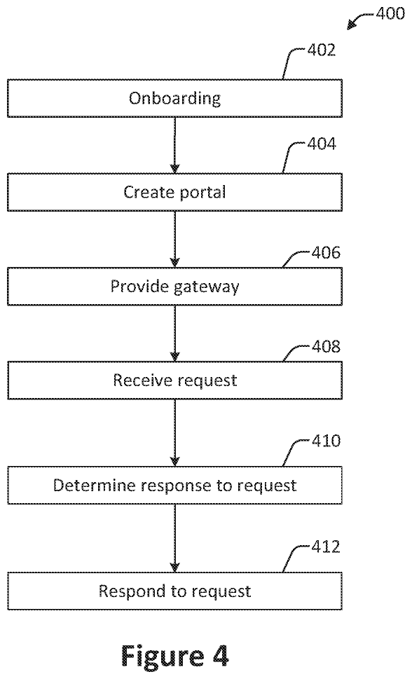

FIG. 4 illustrates an example of a method for end-to-end processing of stored-value cards, in accordance with some implementations. Method 400 of FIG. 4 may be used to associate a reseller with a provider and for the provider to process stored-value card orders as described herein.

In block 402, an onboarding process may be performed. The onboarding process may include the reseller registering with the provider. During the onboarding process, the location data associated with the reseller may be obtained to determine a geographical area associated with the reseller. The geographical area may determine the features that the user is able to select as well as various configurations for the portal.

Based on the onboarding, a portal may be created for the reseller in block 404. The portal may include various features as described herein. Based on the geographical area of the reseller and the preferences of the reseller, features of the portal may be determined. A payment gateway may be provided in block 406. The provider may register a portal that is associated with the gateway for customers to access the reseller.

The gateway may be configured to accept one or a plurality of different payment techniques (e.g., VISA®, Mastercard®, American Express®, Discover®, PayPal®, Skrill®, Authorized.net, cryptocurrencies such as Bitcoin®, Etherium®, and other currencies, bank wire transfer, digital checks, ACH, and other payment techniques). Available payment techniques may be dependent upon the features selected by the reseller as well as the geographical area of the reseller.

In various embodiments, the provider may also provide for marketing services. Thus, for example, the provider may provide online and other advertising. The provider may also spotlight various resellers on their own marketing platform (e.g., on blogs associated with the provider).

After the gateway and portal are set up and a domain is provided for customers to access the reseller's stored-value card store, a request from a customer may be received in block 408. The request may include a request for a new stored-value card, a request to add value to an existing card, a request to redeem value within a stored-value card, a request to cancel a stored-value card, a customer service request, and/or another such request. The request may be received through the portal and/or domain associated with the reseller. Along with the request, location data, identity data, phone number, e-mail address, data of the customer's electronic device, and/or other such data associated with the customer may also be received.

A response to the request may be determined and provided to the request in block 410. Determination of the request may include, for example, analyzing the location data associated with the customer, any payment and identity data entered, the request, and/or other such data. Thus, for example, the location of the customer may be determined. If the location of the customer is outside of the geographic area of the reseller (signifying use of the stored-value card outside of its intended area), the request may be denied. If the location of the customer is within the geographic area of the reseller, the request may be approved or further analysis may be performed.

Such further analysis may include, for example, determining whether the payment and identity data are flagged within the database for possible fraudulent activity, whether the amount the customer has requested or redeemed for the stored-value card is an amount within a threshold amount, whether the customer has requested redemption in two different geographic areas within a threshold period of time (indicating possible fraud), and/or other such analysis. Based on such analysis, it may be determined whether the request is indicative of possible fraud, directed to a transaction that is not allowed, or whether it is an allowable transaction. Based on such a determination the request may be executed or denied.

Based on the determination in block 410, the request may be responded to in block 412. Thus, for example, the request may be processed or rejected based on the determination. In certain requests, such as support requests, support may be offered to the customer by having a customer service representative of the provider contact the customer. In other situations, transactions may be approved or a stored-value card may be created and/or issued. The response may be provided through the domain (e.g., displayed on the website associated with the domain), provided as a message sent to the customer's electronic device, sent in an e-mail, communicated through a phone call, or otherwise communicated to the customer.

FIG. 5 illustrates an example of a method of fraud prevention, in accordance with some implementations. FIG. 5 illustrates a fraud prevention method 500. In block 502, customer data is received (e.g., based on customer on-boarding, requests from the reseller, and/or requests from the customer). The customer data may be received as part of a customer and/or reseller request. Such customer data may include the data described herein. Additionally, in block 504, customer device data may be received. Such device data may include, for example, location data of the customer device as well as device data identifying the customer and/or the electronic device of the customer may be received.

The customer data and the customer device data may be analyzed in blocks 506 and 508, respectively. The analysis of blocks 506 and 508 may be used to detect that the request is possibly fraudulent. Fraud detection techniques used in blocks 506 and 508 may include, for example, determining that a party in another geographic area is attempting to fraudulently conduct transactions through fraud techniques popular in another area, determining that a party is attempting to conduct multiple transactions from a plurality of different areas (possibly through different resellers) within a threshold period of time, that a party is attempting to utilize a stored-value card from a plurality of different areas, that a customer associated with stored-value cards that are associated with a plurality of areas (e.g., one card that is valid in a first country and another card that is valid in a second country) is attempting to utilize both cards within a threshold period of time, that a customer is attempting to request stored-value cards at a rate that is not humanly possible (e.g., attempting to open a plurality of accounts or request a plurality of cards within seconds of each other), that a customer is attempting to request or redeem a stored-value card associated with a first geographic region from a second geographic region, or another such technique.

Based on the analysis of blocks 506 and 508, whether the request is fraudulent may be determined in block 510. Based on the determination, the request may be carried out or denied.

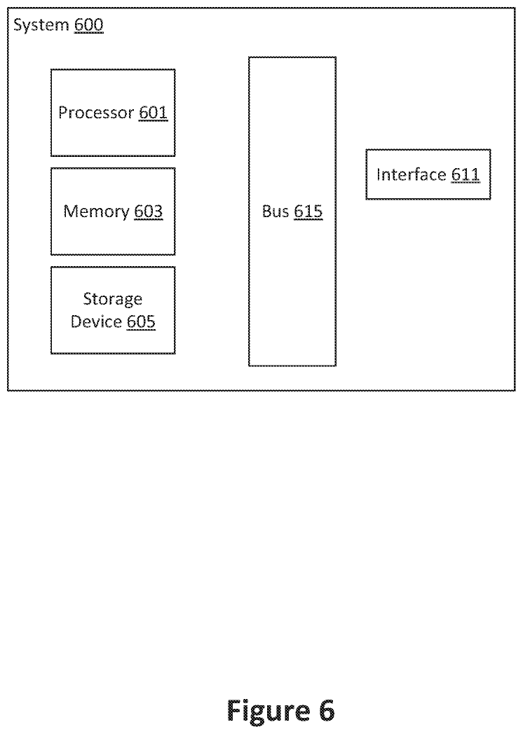

FIG. 6 illustrates one example of a computing device. According to various implementations, a system 600 suitable for implementing implementations described herein includes a processor 601, a memory module 603, a storage device 605, an interface 611, and a bus 615 (e.g., a PCI bus or other interconnection fabric.) System 600 may operate as variety of devices such as a server system such as an application server and a database server, a client system such as a laptop, desktop, smartphone, tablet, wearable device, set top box, etc., or any other device or service described herein. Although a particular configuration is described, a variety of alternative configurations are possible. The processor 601 may perform operations such as those described herein. Instructions for performing such operations may be embodied in the memory 603, on one or more non-transitory computer readable media, or on some other storage device. Various specially configured devices can also be used in place of or in addition to the processor 601. The interface 611 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI), These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices, A non-transitory computer-readable medium may be any combination of such storage devices.

In the foregoing specification, various techniques and mechanisms may have been described in singular form for clarity. However, it should be noted that some implementations include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific implementations including one or more of the best modes contemplated by the inventors. While various implementations have been described herein, it should be understood that they have been presented by way of example only, and not limitation. For example, some techniques and mechanisms are described herein in the context of gifts. However, the disclosed techniques apply to a wide variety of circumstances. Particular implementations may be implemented without some or all of the specific details described herein. In other instances, well known process operations have not been described in detail in order not to unnecessarily obscure the techniques disclosed herein. Accordingly, the breadth and scope of the present application should not be limited by any of the implementations described herein, but should be defined only in accordance with the claims and their equivalents.

1. A system used by a stored-value card provider, the system comprising:
a database comprising a plurality of containers;
a processor, communicatively coupled to the database and configured to perform operations comprising:
receiving, from a first reseller, a request for a first account with the stored-value card provider;
determining a first reseller geographic area associated with the first reseller;
storing the first reseller geographic area within a first container of the database;
providing a first portal associated with the first reseller, the first portal configured according to the first reseller geographic area;
associating a first electronic stored-value card with the first reseller;
receiving, through the first portal, a request from a first customer for the first electronic stored-value card;
determining that a first customer geographic area associated with the first customer matches that of the first reseller geographic area; and
providing the first electronic stored-value card to the first customer.

2. The system of claim 1, wherein the operations further comprise:
receiving, from the first customer, a request to redeem the first electronic stored-value card;
determining that conditions for redeeming the first electronic stored-value card is met; and
processing the request to redeem the first electronic stored-value card.

3. The system of claim 2, wherein the determining that the conditions for redeeming the first electronic stored-value card is met comprises:
determining that a redemption target of the first electronic stored-value card is within the first reseller geographic area.

4. The system of claim 1, wherein the first reseller is associated with the first reseller geographic area and a second reseller geographic area, wherein the database comprises the first container and a second container, wherein data associated with the first reseller for the first reseller geographic area is stored within the first container, and wherein data associated with the first reseller for the second reseller geographic area is stored within the second container.

5. The system of claim 4, wherein the first portal is associated with the first reseller geographic area, and wherein the operations further comprise:
providing a second portal associated with the first reseller and the second reseller geographic area, the second portal configured according to the second reseller geographic area.

6. The system of claim 1, wherein first electronic stored-value card comprises a plurality of functions, and wherein the operations further comprise:
deactivating a first feature of all electronic stored-value cards associated with the first reseller based on the first reseller geographic area.

7. The system of claim 1, wherein the providing the first portal comprises creating a first website associated with the first reseller.

8. The system of claim 1, wherein the operations further comprise:
receiving, from the first customer, a request to add value to the first electronic stored-value card; and
processing the request to add value to the first electronic stored-value card.

9. A method comprising:
receiving, from a first reseller, a request for a first account with a stored-value card provider;
determining a first reseller geographic area associated with the first reseller;
storing the first reseller geographic area within a first container of a database;
providing a first portal associated with the first reseller, the first portal configured according to the first reseller geographic area;
associating a first electronic stored-value card with the first reseller;
receiving, through the first portal, a request from a first customer for the first electronic stored-value card;
determining that a first customer geographic area associated with the first customer matches that of the first reseller geographic area; and
providing the first electronic stored-value card to the first customer.

10. The method of claim 9, wherein the method further comprises:
receiving, from the first customer, a request to redeem the first electronic stored-value card;
determining that conditions for redeeming the first electronic stored-value card is met; and
processing the request to redeem the first electronic stored-value card.

11. The method of claim 10, wherein the determining that the conditions for redeeming the first electronic stored-value card is met comprises:
determining that a redemption target of the first electronic stored-value card is within the first reseller geographic area.

12. The method of claim 9, wherein the first reseller is associated with the first reseller geographic area and a second reseller geographic area, wherein the database comprises the first container and a second container, wherein data associated with the first reseller for the first reseller geographic area is stored within the first container, and wherein data associated with the first reseller for the second reseller geographic area is stored within the second container.

13. The method of claim 12, wherein the first portal is associated with the first reseller geographic area, and wherein the method further comprises:
providing a second portal associated with the first reseller and the second reseller geographic area, the second portal configured according to the second reseller geographic area.

14. The method of claim 9, wherein first electronic stored-value card comprises a plurality of functions, and wherein the method further comprises:
deactivating a first feature of all electronic stored-value cards associated with the first reseller based on the first reseller geographic area.

15. The method of claim 9, wherein the providing the first portal comprises creating a first website associated with the first reseller.

16. The method of claim 9, wherein the method further comprises:
receiving, from the first customer, a request to add value to the first electronic stored-value card; and
processing the request to add value to the first electronic stored-value card.

17. A computer program product comprising one or more non-transitory computer readable media having instructions stored thereon for performing a method, the method comprising:
receiving, from a first reseller, a request for a first account with a stored-value card provider;
determining a first reseller geographic area associated with the first reseller;
storing the first reseller geographic area within a first container of a database;
providing a first portal associated with the first reseller, the first portal configured according to the first reseller geographic area;
associating a first electronic stored-value card with the first reseller;
receiving, through the first portal, a request from a first customer for the first electronic stored-value card;
determining that a first customer geographic area associated with the first customer matches that of the first reseller geographic area; and
providing the first electronic stored-value card to the first customer.

18. The computer program product of claim 17, wherein the method further comprises:
receiving, from the first customer, a request to redeem the first electronic stored-value card;
determining that conditions for redeeming the first electronic stored-value card is met; and
processing the request to redeem the first electronic stored-value card.

19. The computer program product of claim 18, wherein the determining that the conditions for redeeming the first electronic stored-value card is met comprises:
determining that a redemption target of the first electronic stored-value card is within the first reseller geographic area.

20. The computer program product of claim 17, wherein the first reseller is associated with the first reseller geographic area and a second reseller geographic area, wherein the database comprises the first container and a second container, wherein data associated with the first reseller for the first reseller geographic area is stored within the first container, and wherein data associated with the first reseller for the second reseller geographic area is stored within the second container.
